(19) United States
(12) Patent Application Publication
(10) Pub. No.: US 2012/0047945 A1
(43) Pub. Date: Mar. 1, 2012

(54) Bellows Valve for Use in Cryogenics

(75) Inventors: Alain Briglia, Corze (FR); Francine Chommy, Sucy-En-Brie (FR); Emmanuel Garnier, Paris (FR); Thierry Gesbert, Verrieres Le Buisson (FR); Natacha Haik-Beraud, Champigny-Sur-Marne (FR)

(73) Assignee: L'Air Liquide Societe Anonyme Pour L'Etude, Paris (FR)

(21) Appl. No.: 13/318,882

(22) PCT Filed: Apr. 29, 2010
(86) PCT No.: PCT/FR2010/050816

§ 371 Date: Nov. 4, 2011

(30) Foreign Application Priority Data
May 5, 2009 (FR) 0952977

(51) Int. Cl. F25J 3/00; F16K 51/00

(52) U.S. Cl. 62/617; 251/366; 137/1

(57) ABSTRACT

The invention relates to a valve including a circuit for a fluid conveyed into a valve body, a stopper that is movable between a rest position and an operative position from among an open position and a closed position of said circuit, and a resilient annular bellows system connecting said stopper and said body and sealingly closing said circuit in relation to a chamber, wherein the chamber is open towards the outside of the valve via a vent formed in the body, the vent being provided with means for preventing the ingress of wet gas into the body.

The present invention relates to bellows safety valves used on cryogenic fluids.

A bellows valve comprises a circuit for fluid conveyed through a valve body, a sealing member that can move between a rest position and an active position, taken from an open position and a closed position of said circuit, and a resilient annular bellows system for connection between said sealing member and said body, sealing off said circuit.

Bellows valves are safety devices which, by their design, make it possible to accommodate a high back-pressure at exhaust thereof. To do so, it is essential for the body of the valve, called the bonnet, to be in pressure balance with the outside. The balancing function is provided by the vent of the bonnet, and therefore it is essential for this vent not to be obstructed, as indicated in the API 520 standard.

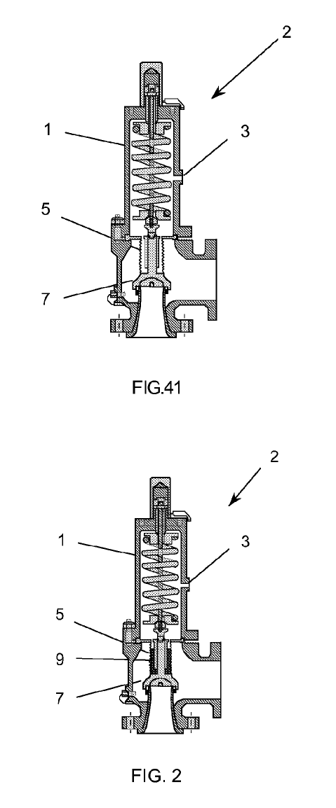

Because of the abovementioned constraints, the use of bellows safety valves in cryogenics is not recommended, or even sometimes prohibited because of the risk of the valve being blocked by the accidental presence of ice 9 in the bellows 5 (FIG. 2), preventing the upward movement of the sealing member or poppet 7 (FIG. 1) of the valve 2. The risk incurred in the event of such an incident may lead to the failure of equipment, causing major damage on a unit, or even fatalities.

The presence of ice 9 (FIG. 2) in the bellows 5 results from the conjunction of two events: the presence of water and a low temperature in the bellows, equal to or below 0° C.

The presence of water may occur through two effects:
condensation of the moisture contained in the ambient air because of natural respiration of the cavity formed by the bonnet 1 of the valve (FIG. 1) via the vent 3 present, owing to day/night temperature variations; and
condensation of the moisture contained in the ambient air because of the cryopumping (capture of moisture on a cold surface) that occurs if there is slight leakage on the valve, which cools the latter below the temperature at which the wet air condenses.

The low temperature may be due to various causes:
ambient temperature;
valve (seat/poppet 7) leakage;
very short distance between the process and the valve, the latter being cooled by conduction or convection.

To overcome the aforementioned problems, it is possible to make use of another valve technology, namely control valves, but the cost of these is substantially higher.

The invention described below makes it possible at very low cost to use the technology of bellows valves in cryogenics by overcoming the aforementioned drawbacks.

As described above, it is the conjunction of two events that make it dangerous to use bellows valves in cryogenics, namely:
the presence of water; and
a cold temperature.

Since the temperature is a parameter on which they may be little influence, the solution consists in permanently having an atmosphere free of any moisture in the cavity formed by the bonnet of the valve (which cavity is in contact via orifices with the inside of the bellows).

According to one subject of the invention, what is provided is a valve of the type comprising a circuit for fluid conveyed through a valve body, a sealing member that can move between a rest position and an active position, taken from an open position and a closed position of said circuit, and a resilient annular bellows system for connection between said sealing member and said body sealing off said circuit, the fluid circuit being open to the outside of the valve through a vent formed in the body, and the vent being provided with means preventing the ingress of wet gas into the body, characterized in that a tube is connected to the vent, this tube being connected to a source of pressurized dry gas.

According to other optional aspects, the valve comprises:
a tube connected to the vent, this tube being connected to a drying means;
a nonreturn valve closing off the tube; and
a tube connected to the vent and provided with a membrane or with a rupture disk.

According to another aspect of the invention, what is provided is the use of a valve as described above at a temperature below 0° C., or even below −50° C.

According to another aspect of the invention, what is provided is a gas separation unit operating by distillation at a temperature below 0° C. in an enclosure, the walls of which are scavenged by a dry gas, the unit including a valve as described above, the fluid being a gas intended for or coming from the distillation and the tube being connected to a wall of the enclosure so that the dry scavenging gas penetrates the tube.

The unit is optionally provided with bellows rupture detection means.

The unit may be a gas separation unit operating by distillation at a temperature below 0° C. that includes a valve as described above, the fluid being a gas intended for or coming from the distillation.

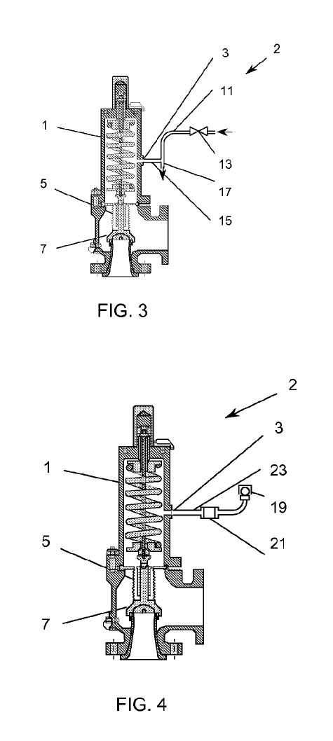

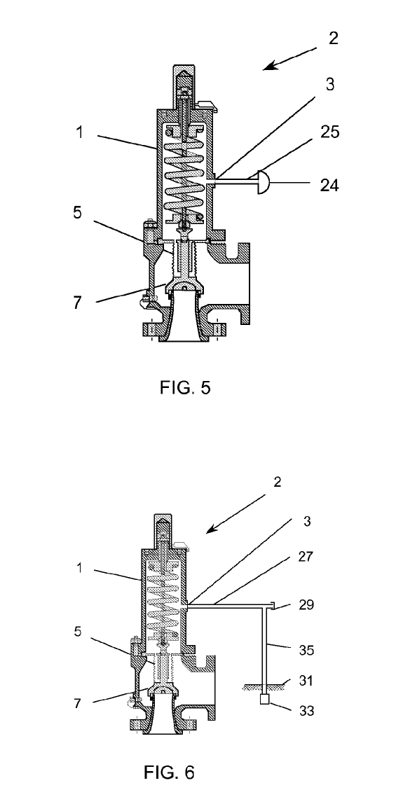

The invention will be described in greater detail with reference to the figures that illustrate the four families of solutions according to the invention:
1. scavenging by a dry gas, illustrated in FIG. 3;
2. dessicator, illustrated in FIG. 4;
3. closure of the vent by a membrane, in FIGS. 5; and
4. collecting of the vent, in FIG. 6.

For all the figures, the basic structure of the bellows valve, illustrated in FIG. 1, is maintained. In FIG. 3, a simple tube 15 is connected to the vent 3 of the bonnet 1 of the valve 2, to which a permanent scavenging stream of dry gas (instrument air, service nitrogen, etc.) passing through the tubes 11, 17 is connected. This thus creates a barrier to the ambient air that could enter the cavity formed by the bonnet of the valve. The flow rate of scavenging gas is controlled by a valve 13.

In FIG. 4, a small device, connected to the vent 3 of the bonnet 1 of the valve 2, minimizes the effect of respiration by a nonreturn valve system 19. This valve is connected to the vent 3 via the tube 23. In addition, given that the system may not be perfectly sealed, a cartridge of a dessicant 21 is inserted into the tube 21 upstream of the valve 19.

In FIG. 5, a small device, connected to the vent 3 of the bonnet 1 of the valve 2, via a tube 25, obstructs the vent in a controlled manner, either by a flexible membrane 24 or by a rupture disk calibrated to a few millibars, the principle being that this closure is broken in the event of a large overpressure due to the bellows 5 rupturing.

In FIG. 6, a simple tube 27 is connected between the vent 3 of the bonnet 1 of the valve 2 and the enclosure 31 of the cold box of a cryogenic separation unit. The bonnet 1 is thus in permanent contact with a dry atmosphere, owing to the permanent scavenging of the enclosure of the cold box with a dry gas, thus preventing any accumulation of water due either to natural respiration or to cryopumping.

A filter element 33 will be installed on the end of the dip tube 35 so as to prevent any entry of perlite.

A T-piece 35 equipped with a plug 29 may also be installed so as to carry out measurements for detecting any rupture of the bellows 5.

1-6. (canceled)

7. A valve of the type comprising a circuit for fluid conveyed through a valve body, a sealing member that can move between a rest position and an active position, taken from an open position and a closed position of said circuit, and a resilient annular bellows system for connection between said sealing member and said body sealing off said circuit, the chamber being open to the outside of the valve through a vent formed in the body, and the vent is provided with means preventing the ingress of wet gas into the body, wherein said valve includes a tube connected to the vent, this tube being connected to a source of pressurized dry gas.

8. A flow control method comprising:
a) conveying a fluid through a circuit through a valve body,
b) moving a sealing member that can move between a rest position and an active position, resulting in the movement from an open position and a closed position of said circuit,
c) connecting between said sealing member and said body sealing off said circuit a resilient annular bellows system,
d) allowing the chamber to open to the outside of the valve through a vent formed in the body, and the vent being provided with means preventing the ingress of wet gas into the body, wherein said valve includes a tube connected to the vent, and
e) connecting this tube to a source of pressurized dry gas.

9. The flow control method of claim 8, wherein said fluid is at a temperature below 0° C.

10. The flow control method of claim 8, wherein said fluid is at temperature below −50° C.

11. A gas separation unit operating by distillation at a temperature below 0° C. that includes the valve in claim 8, the fluid being a gas intended for or coming from the distillation

12. A gas separation unit operating by distillation at a temperature below 0° C. in an enclosure, the walls of which are scavenged by a dry gas, the unit comprising the valve in claim 7, the fluid being a gas intended for or coming from the distillation and the tube being connected to a wall of the enclosure so that the dry scavenging gas penetrates the tube.

13. The unit in claim 12, provided with bellows rupture detection means.
